(19) United States
(12) Patent Application Publication
(10) Pub. No.: US 2013/0329182 A1
(43) Pub. Date: Dec. 12, 2013

(54) INTERLOCKING TEMPLE CONNECTORS FOR EYEWEAR AND ASSOCIATED EYEWEAR APPARATUSES

(71) Applicant: Murray Kendall Wilson, San Diego, CA (US)

(72) Inventor: Murray Kendall Wilson, San Diego, CA (US)

(21) Appl. No.: 13/689,745

(22) Filed: Nov. 29, 2012

Related U.S. Application Data
(60) Provisional application No. 61/629,890, filed on Nov. 29, 2011.

(51) Int. Cl. G02C 5/22

(52) U.S. Cl. CPC G02C 5/2254; G02C 5/22
USPC 351/153

(57) ABSTRACT

A specialized eyewear hinge and attachment device for creating a tool-less eyewear arm changeout system and creating the possibility of turning sunglasses into goggles quickly and easily. The specialized hinge and mating system for eyewear allows for rapid changes of either eyewear stems, the conversion of an eyeglass into a goggle, and/or allows the improved living hinge system to apply an inward pressure which allows for a more secure eyewear fit. The specialized mating system of the hinge to the frame utilizes a pliable hinge material with female apertures to mate with a rigid male protrusion portion on the eyewear frame and stems.

### FIELD OF THE INVENTION

The present invention relates generally to a specialized eyewear hinge and attachment device, and more specifically to eyewear apparatuses utilizing the specialized hinge connectors to create a tool-less eyewear stem/arm change out system and or a rapid modification of an eyeglass into a goggle.

### BACKGROUND OF THE INVENTION

The disadvantage with most eyewear is that the weakpoint in most glasses is the hinge portion. A high level of stress placed on typical eyewear hinges, thus the hinges are secured with combinations of screws, rivets and pins, and when a hinge is overstressed or over extended the result is either a break in the frame, the hinge or the stem of the sunglass itself.

Additionally, eyeglasses are often worn in situations were an eye goggle would be more appropriate, which often further results in eyewear breakage or even injury to the user.

The present invention solves the problems associated with standard eyewear hinges and allows for a mating system of function and materials which allows for strong hinge forces to be encountered without a breakage in the eyewear apparatus. The present invention comprises a rapidly interchangeable and tool-less hinge interchange system which allows for a hinge to be securely placed but also displaced without breaking the eyewear frame, hinge or stem. Additionally, the hinge system allows for the rapid versatility of turning a hinge system for eyewear into an attachment system for a goggle.

### SUMMARY OF THE INVENTION

The present invention relates generally to a specialized eyewear hinge and attachment device, and more specifically to eyewear apparatuses utilizing the specialized hinge connectors to create a tool-less eyewear stem/arm change out system and or a rapid modification of an eyeglass into a goggle.

An embodiment of the present invention includes an eyewear and stem attachment connector featuring a frame attachment portion with a female recess for mating with a male portion of an eyewear frame. The stem attachment connector additionally features a hinge portion which includes a living hinge which provides tension in a directional manner such that the hinge is perpetually attempting to move into a closed position. The stem attachment connector contemplated further features a stem attachment portion which includes a female recess for mating with a male portion of an eyewear stem.

In additional embodiments the attachment connector may be made of a pliable material that is expandable to mate around a rigid male connection protrusion such as a flexible rubber or plastic wherein a flexible rubber material comprising a hardness as measured by durometer on a type a ASTM 2240 tester ranging from 75 to 95 with 85 being most preferred.

Another embodiment of the present invention features modifiable eyewear apparatus comprising: viewable lenses, an eyewear frame, two eyewear stems and two eyewear and stem attachment connectors. The embodied eyewear frame further comprises left and right temple connection points which each include a male protrusion for mating with a female recess. The embodied eyewear and stem attachment connector further includes; a) a frame attachment portion, wherein said frame attachment portion comprising a female recess for mating with a male portion of an eyewear frame; b) a hinge portion, wherein said hinge portion comprises a living hinge which provides tension in a directional manner such that the hinge is attempting to move into a closed position; and c) a stem attachment portion, wherein the stem attachment portion comprises a female recess for mating with a male portion of an eyewear stem.

Additional embodiments include the connector with the properties as stated above including a flexible material. Additionally the frame and eyewear stems are made of a rigid material selected from stainless steel, aluminum, and carbon and graphite composite materials with aluminum most preferred.

Another additional embodiment features a modifiable eyewear apparatus comprising: viewable lenses, an eyewear frame, two eyewear stems; two eyewear and stem attachment connectors; two optional goggle attachment connectors and a goggle strap. In the present embodiment the eyewear apparatus may be converted from an eyeglass with attached stems for securing the eyewear to a user's head to a goggle with an attached goggle strap replacing the stems and securing the eyewear around the user's head.

When the embodied apparatus is desired to be worn as an eyeglass an eyewear and stem connector and stems are utilized; and the eyewear and stem attachment connector further comprises: a) a frame attachment portion, wherein said frame attachment portion comprising a female recess for mating with a male portion of an eyewear frame; b) a hinge portion, wherein said hinge portion comprises a living hinge which provides tension in a directional manner such that the hinge is attempting to move into a closed position; and c) a stem attachment portion, wherein the stem attachment portion comprises a female recess for mating with a male portion of an eyewear stem.

When the embodied apparatus is desired to be worn as a goggle a goggle strap and eyewear and goggle connectors are utilized; said eyewear and goggle connectors further comprises: a) a goggle and frame attachment portion, wherein said goggle and frame attachment portion comprising a goggle connector female recess for mating with the male portion of the eyewear frame; and b) a google strap attachment aperture.

The embodied interchangeable hinge and goggle connector system is designed for a tool less exchange system wherein the specialized mating between the frame and connectors allows for a secure attachment without the need for screws, rivets or pins as in common in the art.

The embodied frame contemplated is made from a very durable solid material such as aluminum, carbon or other rigid material members; and the male protrusion member is a solid member that is not easily bent or flexed and wherein the male protrusion member mates with a pliable hinge or goggle connection member which includes wherein the male member is engulfed within the recesses of the female member and secured by surrounding the member.

Yet additional embodiments feature a male stem connective member that has an upward protrusion, and a downward protrusion and the female member includes a top recess, a middle recess and a bottom recess wherein the top protrusion of the frame mates within the top recess of the female member, the middle protrusion mates within the middle recess of the female member and the bottom protrusion mates with the bottom recess of the female member. The three point contact between the male protrusions and the female recesses is designed such that a linear pull on the stems on a plane away from the back of the frame only secures the mating stronger by contracting the recess further against the protrusions. Thus the hinge removal is accomplished by exerting a downward or upwards force on the hinge to break the one contact point at a time starting with either the top or bottom contact point.

### BRIEF DESCRIPTION OF THE DRAWINGS

The invention will be better understood and objects other than those set forth above will become apparent when consideration is given to the following detailed description thereof. Those of skill in the art will understand that the drawings, described below, are for illustrative purposes only. The drawings are not intended to limit the scope of the present teachings in any way. Such description makes reference to the annexed drawing wherein:

FIG. 1 comprises of FIG. 1A, 1B, 1C, and 1D which each represent a connector embodiment contemplated in the present invention in various views. FIG. 1A. is a top view, 1B and 1C are side views and 1D is a perspective view.

FIG. 2 comprises of FIG. 2A-2F, represents the connector embodiment of FIG. 1 when attached to an eyewear apparatus.

FIG. 3 comprises of FIG. 3A-3E, represents multiple views of a the connector embodiment again with an eyewear apparatus.

FIG. 4 comprises FIG. 4A-4D which shows the eyewear component of FIGS. 2 and 3 without a connector attached.

FIG. 5 comprises FIG. 5A-5I which shows and eyewear apparatus that has been converted to a goggle through the use of a goggle strap connector.

### DETAILED DESCRIPTION OF THE PREFERRED EMBODIMENTS

The embodiments of the present invention are designed to provide for a rapid and tool-less interchangeable hinge attachment system for eyewear. The hinge system comprises of a female frame mounting aperture a connective hinge and a female stem mounting aperture. Additional embodiments feature a rapidly interchangeable goggle strap attachment piece which may be used instead of the hinge attachment system to convert the eyeglass into a goggle. The goggle strap attachment piece comprises a female mounting aperture and an aperture for a goggle strap.

The hinge system contemplated may include a thermal plastic rubber like material molded that can interlock onto a sunglass frame at the temple region. The embodied molded part design can connect the front frame to the side temple stems or a goggle strap to keep eyewear in position. The thermal plastic connector has at least one female inter shape that can accept a male counterpart. Said male counterpart could be a sunglass temple stem or a rubber tip with a hole to retain a goggle strap. The connector could also act as a hinge that is flexible and allows the temple to move in two directions inward and outward. The connector could also have a hole to pass through and accept a strapping such as elastic, nylon, leather, or goggle strap that allows the frame to be held onto a human head.

The embodied hinge is designed to interlock with the frame member and the temple stems. By connecting a male and female shape part, the two parts interlock to keep from coming apart and acting as one. The connector may be made from flexible rubber like material that is on the D scale for hardness at 40 durometer.

The embodied hinge connector may also act as a living hinge and can flex back and forth without breaking. The plastic rubber like hinge may be taken on and off as many times as desired. The interlocking parts where one part is hard and the other part is soft allow for flexibility, so the part can be soft female part may be pulled off the male more rigid male counterpart.

Additional contemplated embodiments allow for the connector attached at the frame and a hole or gap to allow for a goggle strap to pass through. The modified connector contemplated thus works as a retainer for the goggle strap holder.

The temple connector is also made of soft rubber like material and the frame is made of harder material. This allows the temple connector the ability to stretch and flex to be able to take on and off. The interlocking feature is not exposed when assembled together as one unit, acting as a pair of sunglasses or sunglasses with a goggle strap attached at the temples. The plastic rubber material has internal shape of a female, while the counter part is shaped like a male. The male part is made from a harder material than the connector.

Additional embodiments include eyewear frame comprising left and right side male protrusions for mating with the hinge attachment piece via the female frame mounting aperture; and wherein the left and right side male protrusions additionally mate with the interchangeable goggle strap attachment piece via the female frame mounting aperture.

The interchangeable hinge and goggle connector system is designed for a tool less exchange system wherein the specialized mating between the frame and connectors allows for a secure attachment without the need for screws, rivets or pin attachment means as is common in the art.

The frame is made from a very durable solid material such as aluminum, carbon or other rigid material members; and the male protrusion member is a solid member that is not easily bent or flexed and wherein the male protrusion member mates with a pliable hinge or goggle connection member which includes wherein the male member is engulfed within the recesses of the female member and secured by surrounding the member.

The male stem connective member has an upward protrusion, and a downward protrusion and the female member includes a top recess, a middle recess and a bottom recess wherein the top protrusion of the frame mates within the top recess of the female member, the middle protrusion mates within the middle recess of the female member and the bottom protrusion mates with the bottom recess of the female member.

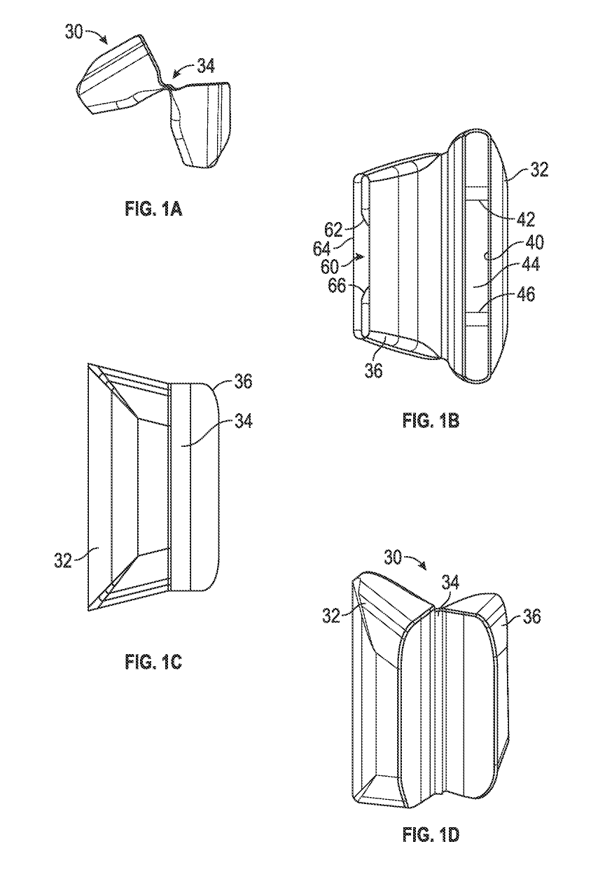

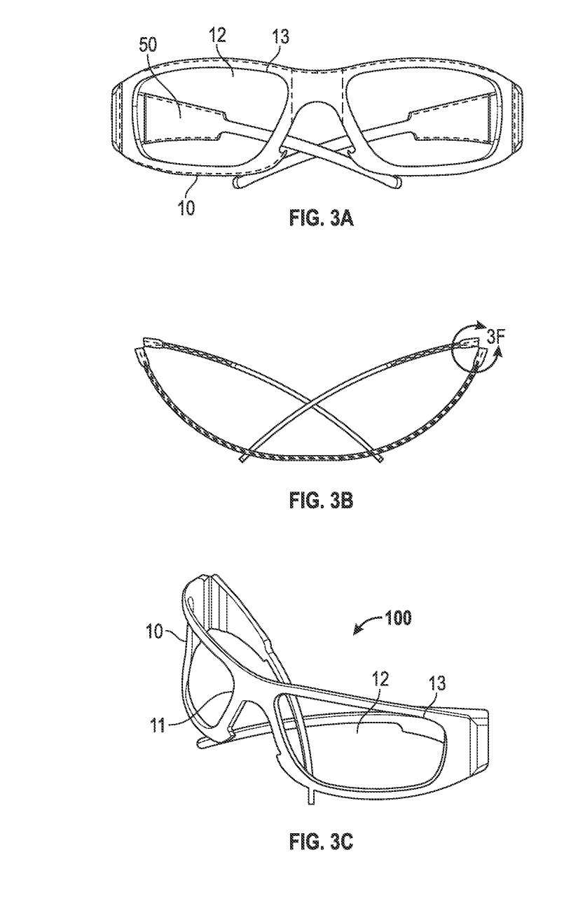

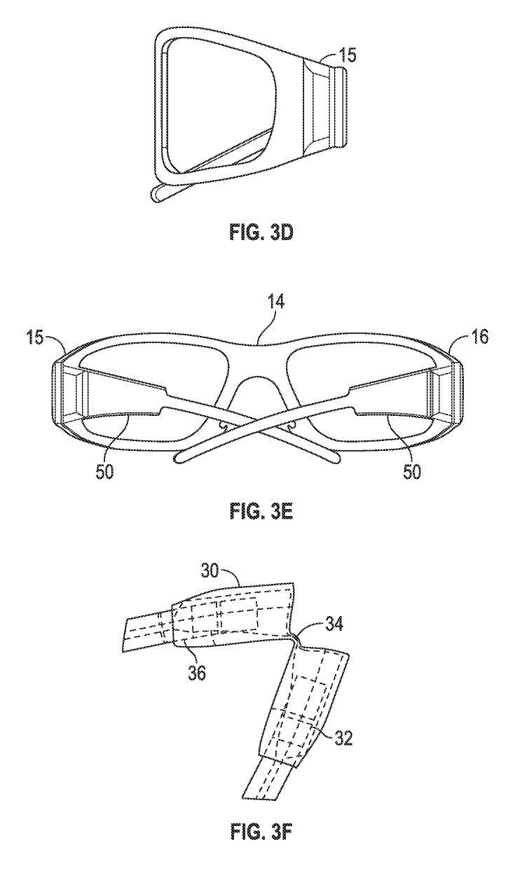

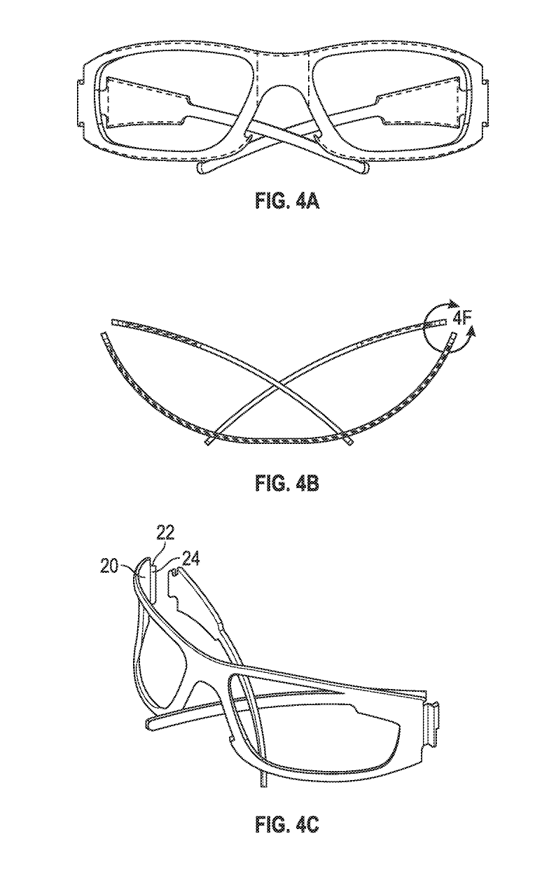

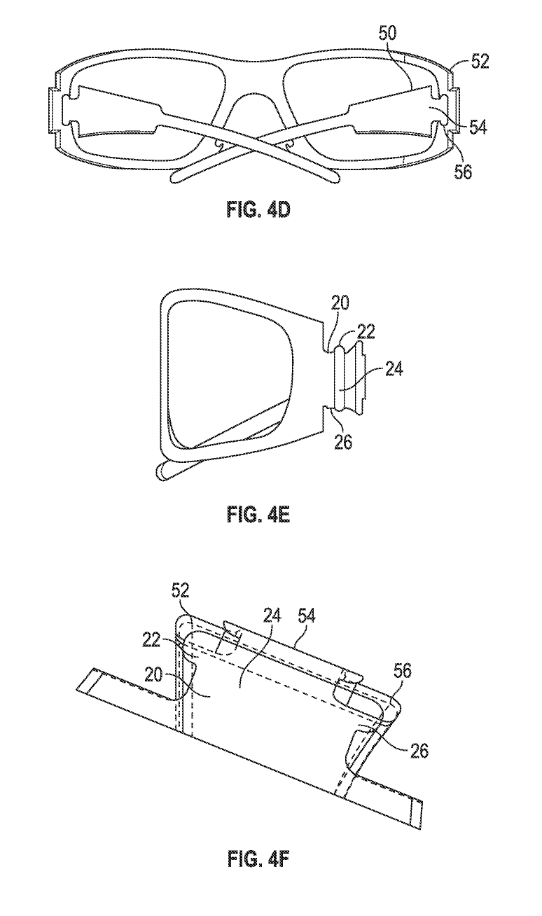

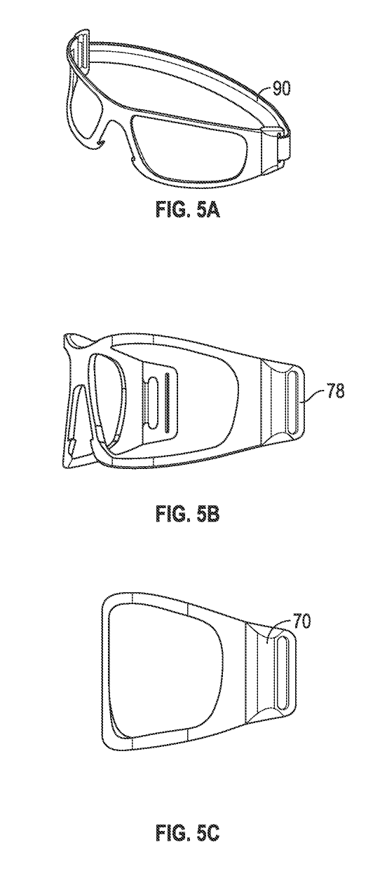

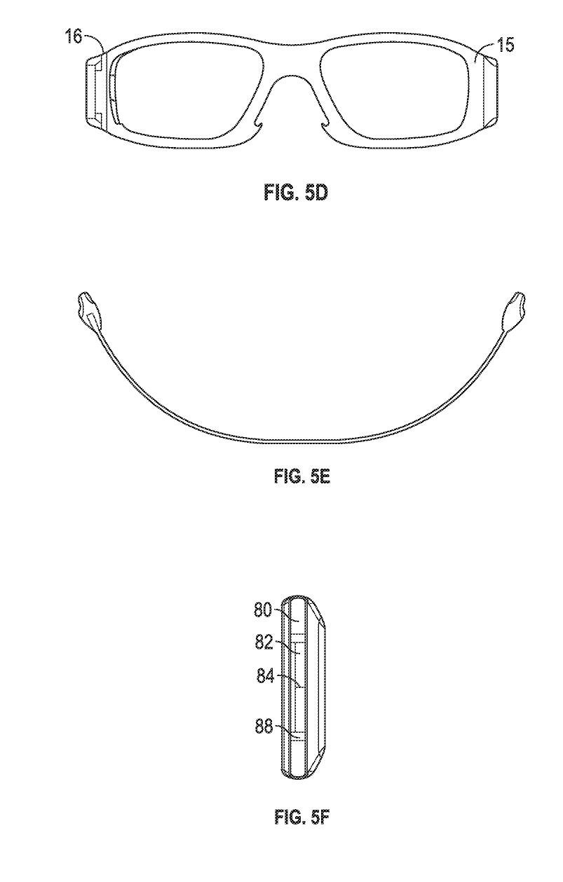

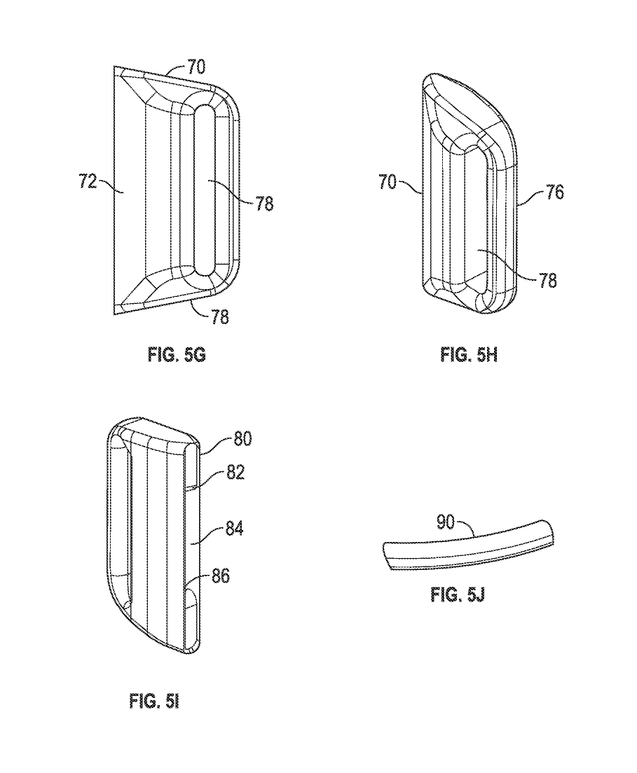

Referring to FIGS. 1-5 the following descriptions and parts apply:

An embodiment of the present invention is for an eyewear apparatus 100 comprising an eyewear face 10 which further includes a rigid frame portion 11 and a lens portion 12 and wherein the front face 13 of the frame 11 faces away from a user and the back face 14 of the frame 11 rests on the wearer. While resting on the head of a wearer the frame 11 has a left temple connection point 15 and a right temple connection point 16 which are secured in the general area around the wearer's left and right temples, respectively, when the eyewear apparatus 100 is placed correctly on a user. The temple connection points 15 and 16 are generally used as attachment points for securing the eyewear apparatus 100 to the user so that the eyewear is not easily displaced from its point of use.

The temple connection points 15 and 16 additionally have a male frame attachment protrusion 20 which comprises a top protrusion 22 a middle protrusion 24 and bottom protrusion 26 which mate with either a stem attachment connector 30 or a goggle strap connector 70.

The stem attachment connector 30 contemplated in the present invention comprises a frame attachment portion 32 a hinge portion 34 and a stem attachment portion 36. Generally, the frame attachment portion 32 attaches to the eyewear frame 10, the stem attachment portion 36 attaches to temple stems 50 which serve as securing arms that grip the side of the wearers head, a the hinge portion 34 is designed to fold the temple stems 50 inward towards the back face 14 of the eyewear face 10 when the eyewear 100 is in the stored or non-use position.

Additionally, the frame attachment connector 32 is the part of the connector 30 which attaches directly with the eyewear face 10 via mating with the male attachment protrusion 20. This mating occurs more specifically by mating the frame attachment female recess 40 of the frame attachment portion 32 with the male attachment protrusion 20 found on the eyewear face 10. The frame attachment female recess 40 includes three contact points, a top recess 42, a middle recess 44 and a bottom recess 46 for securing the frame attachment portion 32 to the eyewear face 10 via the male attachment protrusion 20. Additionally, as described above the male attachment protrusion 20 has three contact points, a top protrusion 22, a middle protrusion 24, and a bottom protrusion 26. The mating of the frame attachment portion 32 is complete when the three contact points of the male attachment protrusion 20 are secured within the three contact points of the frame female attachment recess 40 such that the top protrusion 22 is in the top recess 42, the middle protrusion 24 is in the middle recess 44 and the bottom protrusion 26 is in the bottom recess 46.

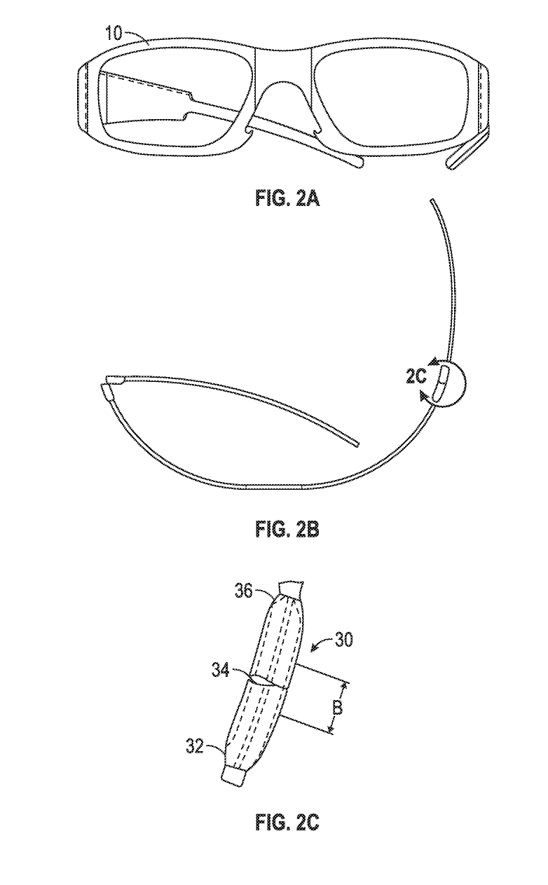

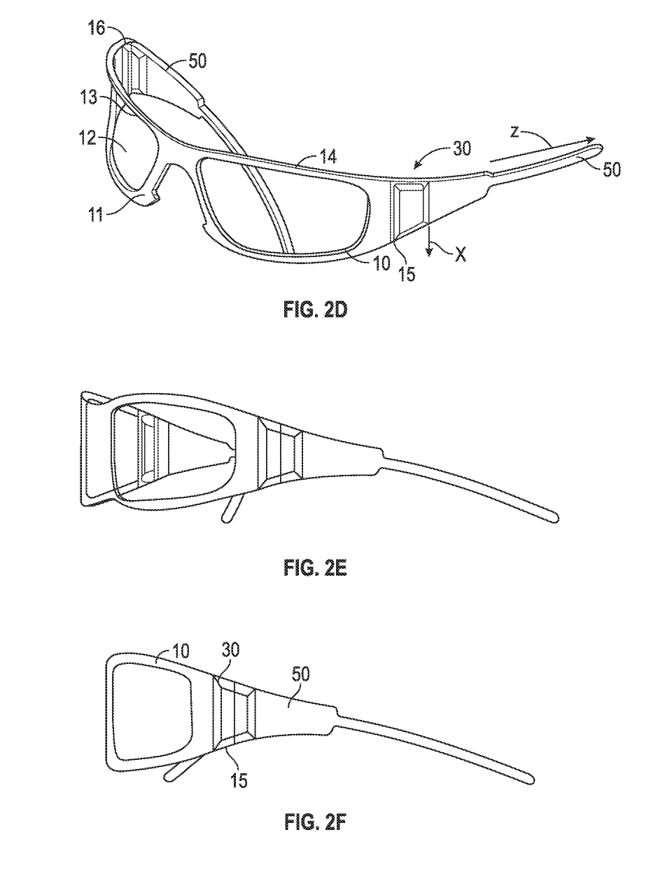

The three point contact between the male protrusions and the female recesses is designed such that a linear pull (as shown by line Z in FIG. 2D) on the stems on a plane away from the back of the frame only secures the mating stronger by contracting the recess further against the protrusions. Thus the hinge removal is accomplished by exerting a downward or upwards force (as shown by directional arrow X) on FIGS. 2D and 2F) on the hinge to break the one contact point at a time starting with either the top or bottom contact point.

The stem attachment connector 30 is generally designed so that it is pliable enough to allow the recesses 40 and 60 to expand to allow the non-pliable rigid protrusions of the temple stem 42, 44, and 46 and the male attachment protrusion 20 to expand into the recesses 40 and 60 upon placement of the protrusions within the recesses and then have the recesses 40 and 60 contract against the protrusions to create a snug secure fit. Generally the stems 50 and frames 10 and their accompanying protrusion members are made of a rigid non-pliable material such as carbon, graphite or metals, with aluminum being most preferred. Alternatively, the stem attachment connector 30 is made of a pliable material such as rubber with a firm durometer such that the material is strong and will not tear easily and can secure objects in place.

The stem attachment connector 30 also includes a hinge portion 34 which may be a living hinge which provides tension in a directional manner such that when the stems 50 are connected onto the eyewear face 10 the hinge 34 pulls the stems 50 inward towards the back face 14 of the eyewear face 10. This living hinge tension allows the stems 50 to be pulled more securely against the side of a wearers head while the eyewear apparatus 100 is being worn, and allows the stems 50 to be pulled into proximity of the back face 14 of the eyewear face 10 and into a folded and stored position when the eyewear apparatus 100 is not worn.

The temple stems 50 are secured to the stem attachment portion 36 of the stem attachment connector 30 through a similar male portion female recess interaction as described above. In this case the temple stems 50 have three contact point protrusions a stem top protrusion 52, a stem middle protrusion 54, and a stem bottom protrusion 56 which mate with the stem attachment recess 60 located on the stem attachment portion 36 of the stem attachment connector 30. The stem attachment recess 60 also includes three contact points including top stem recess 62, middle stem recess 64 and bottom stem recess 66. The mating of the stem attachment portion 36 is complete when the three contact points temple stems 50 are secured within the three contact points of the stem female attachment recess 60 such that the top stem protrusion 52 is in the top stem recess 62, the middle stem protrusion 54 is in the middle stem recess 64 and the bottom stem protrusion 56 is in the bottom stem recess 66.

The temple stems 50 additionally include an elongated stem arm 58 which extends from the temple connection point along a wearer's head and is designed to have a portion which rests on the bridge of the ears of a user.

An included or alternative eyewear apparatus 200 includes the same eyewear face 10 as above, but instead of having a stem attachment connector 30 a goggle strap connector 70 is mated to the eyewear face 10 instead.

An embodiment of the present invention is for an eyewear apparatus 200 comprising an eyewear face 10 which further includes a rigid frame portion 11 and a lens portion 12 and wherein the front face 13 of the frame 11 faces away from a user and the back face 14 of the frame 11 rests on the wearer. While resting on the head of a wearer the frame 11 has a left temple connection point 15 and a right temple connection point 16 which are secured in the general area around the wearer's left and right temples, respectively, when the eyewear apparatus 200 is placed correctly on a user. The temple connection points 15 and 16 are generally used as attachment points for securing the eyewear apparatus 200 to the user so that the eyewear is not easily displaced from its point of use.

The temple connection points 15 and 16 additionally have a male frame attachment protrusion 20 which comprises a top protrusion 22 a middle protrusion 24 and bottom protrusion 26 which mate with a goggle strap connector 70.

The goggle strap connector 70 contemplated in the present invention comprises a frame attachment portion 72 and a goggle attachment portion 76. Generally, the frame attachment portion 72 attaches to the eyewear frame 10, the goggle attachment portion 76 attaches to a goggle strap 90 which serves to secure the the back face 14 of the eyewear face 10 to the wearers face when in use.

Additionally, the frame attachment connector 72 is the part of the goggle strap connector 70 which attaches directly with the eyewear face 10 via mating with the male attachment protrusion 20. This mating occurs more specifically by mating the frame attachment female recess 80 of the frame attachment portion 72 with the male attachment protrusion 20 found on the eyewear face 10. The frame attachment female recess 80 includes three contact points, a top recess 82, a middle recess 84 and a bottom recess 86 for securing the frame attachment portion 72 to the eyewear face 10 via the male attachment protrusion 20. Additionally, as described above the male attachment protrusion 20 has three contact points, a top protrusion 22, a middle protrusion 24, and a bottom protrusion 26. The mating of the frame attachment portion 72 is complete when the three contact points of the male attachment protrusion 20 are secured within the three contact points of the frame female attachment recess 80 such that the top protrusion 22 is in the top recess 82, the middle protrusion 24 is in the middle recess 84 and the bottom protrusion 26 is in the bottom recess 86.

The goggle strap connector 70 is generally designed so that it is pliable enough to allow the female attachment recess 80 to expand to allow the non-pliable rigid male attachment protrusion 20 to expand into recess 80 upon placement of the protrusion 20 within the recess 80 and then have the recess 80 contract against the protrusion 20 to create a snug secure fit. Generally the frame 10 and its accompanying protrusion members are made of a rigid non-pliable material such as carbon, graphite or metals, with aluminum being most preferred. Alternatively, the goggle attachment connector 80 is made of a pliable material such as rubber with a firm durometer such that the material is strong and will not tear easily and can secure objects in place.

The goggle strap connector 70 also includes a goggle attachment part 76 which includes a goggle strap attachment aperture 78 so that when a goggle strap 90 is connected onto the eyewear face 10 the goggle strap 90 pulls the eyewear face 10 more securely against the face of the wearer.

The goggle strap 90 is secured to the goggle attachment portion 76 of the goggle strap connector 70 through a goggle strap attachment aperture 78. A goggle strap 90 is secured by extending the goggle strap 90 through goggle strap apertures 78 on the google attachment portion which are located near the left and right temple connection points 15 and 16 of the eyewear apparatus 200.

Having described the invention in detail, it will be apparent that modifications, variations, and equivalent embodiments are possible without departing the scope of the invention defined in the appended claims. Furthermore, it should be appreciated that all examples in the present disclosure are provided as non-limiting examples.

What is claimed is:

1. A eyewear and stem attachment connector comprising:
a) a frame attachment portion, wherein said frame attachment portion comprises a female recess for mating with a male portion of an eyewear frame;
b) a hinge portion, wherein said hinge portion comprises a living hinge which provides tension in a directional manner such that the hinge is attempting to move into a closed position; and
c) a stem attachment portion, wherein the stem attachment portion comprises a female recess for mating with a male portion of an eyewear stem.

2. The stem attachment connector of claim 1 wherein said attachment connector is made of a pliable material that is expandable to mate around a rigid male connection protrusion.

3. The stem attachment connector of claim 1 wherein said attachment connector is made of flexible rubber.

4. The stem attachment connector of claim 1 wherein said connector is made from a flexible rubber material comprising a D scale for hardness at 40 durometer.

5. A modifiable eyewear apparatus comprising: viewable lenses, an eyewear frame, two eyewear stems and two eyewear and stem attachment connectors;
wherein said eyewear frame further comprises left and right temple connection points which each include a male protrusion for mating with a female recess;
wherein said eyewear and stem attachment connector further comprises
a) a frame attachment portion, wherein said frame attachment portion comprising a female recess for mating with a male portion of an eyewear frame;
b) a hinge portion, wherein said hinge portion comprises a living hinge which provides tension in a directional manner such that the hinge is attempting to move into a closed position; and
c) a stem attachment portion, wherein the stem attachment portion comprises a female recess for mating with a male portion of an eyewear stem.

6. The eyewear apparatus of claim 5 wherein said attachment connector is made of a pliable material that is expandable to mate around a rigid male connection protrusion.

7. The eyewear apparatus of claim 5 wherein said attachment connector is made of flexible rubber.

8. The eyewear apparatus of claim 5 wherein said connector is made from a flexible rubber material comprising a D scale for hardness at 40 durometer.

9. The eyewear apparatus of claim 5 wherein the frame and eyewear stems are made of a rigid material selected from stainless steel, aluminum, and carbon and graphite composite materials.

10. A modifiable eyewear apparatus comprising: viewable lenses, an eyewear frame, two eyewear stems; two eyewear and stem attachment connectors; two optional goggle attachment connectors and a goggle strap;
wherein said eyewear apparatus may be converted from an eyeglass with attached stems for securing the eyewear to a user's head to a goggle with an attached goggle strap replacing the stems and securing the eyewear around the user's head;
wherein said eyewear frame further comprises left and right temple connection points which each include a male protrusion for mating with a female recess;
wherein when said eyewear apparatus is desired to be worn as an eyeglass an eyewear and stem connector and stems are utilized;
said eyewear and stem attachment connector further comprises
a) a frame attachment portion, wherein said frame attachment portion comprising a female recess for mating with a male portion of an eyewear frame;
b) a hinge portion, wherein said hinge portion comprises a living hinge which provides tension in a directional manner such that the hinge is attempting to move into a closed position; and
c) a stem attachment portion, wherein the stem attachment portion comprises a female recess for mating with a male portion of an eyewear stem;
wherein when said eyewear apparatus is desired to be worn as goggle a goggle strap and eyewear and goggle connectors are utilized;
said eyewear and goggle connectors further comprises
a) a goggle and frame attachment portion, wherein said goggle and frame attachment portion comprising a goggle connector female recess for mating with the male portion of the eyewear frame; and
b) a google strap attachment aperture.
